(19) United States
(12) Patent Application Publication
(10) Pub. No.: US 2026/0363961 A1
(43) Pub. Date: Nov. 19, 2026

(54) INFANT BOTTLE HOLDING DEVICE

(71) Applicant: Vance Johnson, Chateaugay, NY (US)

(72) Inventor: Vance Johnson, Chateaugay, NY (US)

(21) Appl. No.: 19/207,582

(22) Filed: May 14, 2025

(51) Int. Cl. A61J 9/06

(52) U.S. Cl. CPC A61J 9/063; A61J 9/0661; A61J 9/0692

(57) ABSTRACT

An infant bottle holding device includes a support for holding an infant bottle, a mount for securement to a supporting structure, and a shaft coupled to the support and the mount. The shaft is resiliently deformable such that the shaft bends between a drinking position and a support position. The drinking position supports the infant bottle in a tilted position having a nipple of the infant bottle facing downwardly. The shaft extends upwardly from the mount to hold the infant bottle with the nipple facing upwardly inhibiting spillage from the infant bottle through the nipple in the support position.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to infant bottle holding devices and more particularly pertains to a new infant bottle holding device for supporting an infant bottle between a drinking position allowing the bottle to be held by an infant and a withdrawn position preventing the bottle from falling onto a ground surface.

### (2) Description of Related Art Including Information Disclosed Under 37 CFR 1.97 and 1.98

The prior art relates to infant bottle holding devices. Known prior art lacks resilient deformation of a support shaft allowing an infant to hold a bottle and preventing the bottle from falling when released by the infant.

### (h) BRIEF SUMMARY OF THE INVENTION

An embodiment of the disclosure meets the needs presented above by generally comprising a support for holding an infant bottle, a mount for securement to a supporting structure, and a shaft coupled to the support and the mount. The shaft is resiliently deformable such that the shaft bends between a drinking position and a support position. The drinking position supports the infant bottle in a tilted position having a nipple of the infant bottle facing downwardly. The shaft extends upwardly from the mount to hold the infant bottle with the nipple facing upwardly inhibiting spillage from the infant bottle through the nipple in the support position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a infant bottle holding device according to an embodiment of the disclosure.

FIG. 2 is a front view of an embodiment of the disclosure.

FIG. 3 is a partial side view of an embodiment of the disclosure.

FIG. 4 is a detailed cut away view of an embodiment of the disclosure corresponding to line 4 in FIG. 3.

FIG. 5 is a bottom detailed view of an embodiment of the disclosure corresponding to line 5 in FIG. 3.

### (j) DETAILED DESCRIPTION OF THE INVENTION

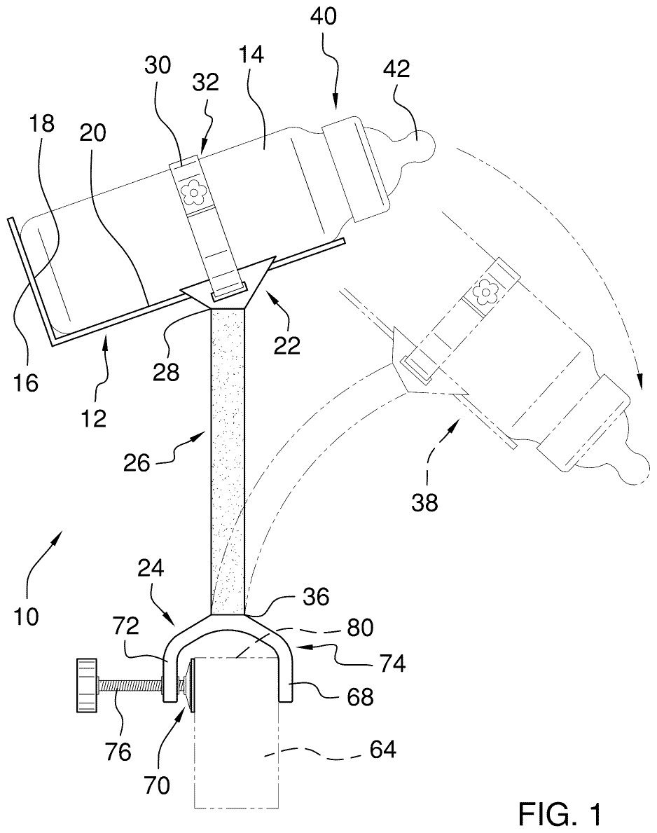

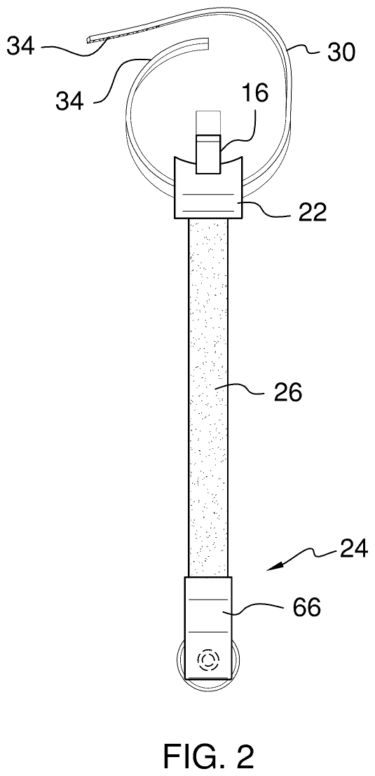

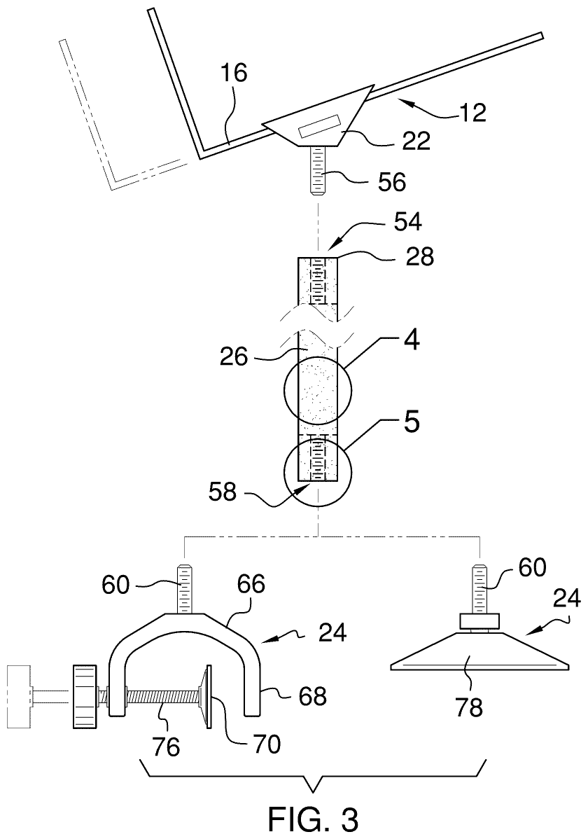

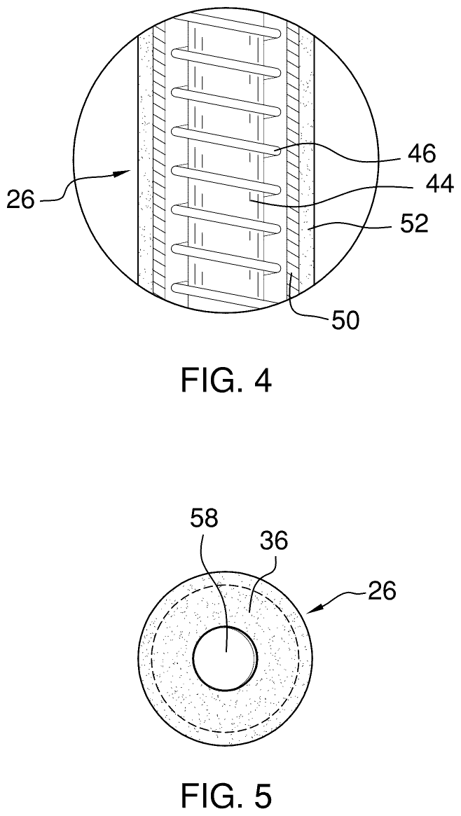

With reference now to the drawings, and in particular to FIGS. 1 through 5 thereof, a new infant bottle holding device embodying the principles and concepts of an embodiment of the disclosure and generally designated by the reference numeral 10 will be described.

As best illustrated in FIGS. 1 through 5, the infant bottle holding device 10 generally comprises a support 12 configured for holding an infant bottle 14. The support 12 includes a bracket 16, a mount 24 and a shaft 26 extending between the bracket 16 and the mount 24. The bracket 16 is L-shaped. Thus, the bracket 12 is configured for extending along a bottom 18 and a side 20 of the infant bottle 14. A bracket connector 22 is coupled to the bracket 16 and a first end 28 of the shaft 26. A strap 30 is coupled to the bracket connector 22 such that the strap 30 is configured for extending around the bracket 16 and the infant bottle 14. The strap 30 is securable into a closed loop 32 wherein the strap 30 is configured for securing the infant bottle 14 to the support 12, specifically the bracket 16. Complementary portions of hook and loop fastener 34 are coupled to the strap 30 for securing the strap 30 in the closed loop 32.

The shaft 26 has the a first end 28 coupled to the support 12 and a second end 36 coupled to the mount 24. The shaft 26 is resiliently deformable such that the shaft 26 is configured for bending between a drinking position 38 and a support position 40. The drinking position 38 is configured for supporting the infant bottle 14 in a tilted position having a nipple 42 of the infant bottle 14 facing downwardly allowing an infant to drink from the infant bottle 14. The support position 40 has the shaft 26 extending upwardly from the mount 24 wherein the support 12 is configured to hold the infant bottle 14 with the nipple 42 of the infant bottle 14 facing upwardly inhibiting spillage from the infant bottle 14 through the nipple 42. The shaft 26 includes a core 44. The core 44 is elongated between the first end 28 of the shaft 26 and the second end 36 of the shaft 26. The core 44 is constructed of a resiliently deformable material such as rubber, plastic, or the like. Additionally, the shaft 26 includes a spring 46. The spring 46 is helical. The core 44 extends through a center of the spring 46 such that the spring 46 wraps around the core 44 from the first end 28 of the shaft 26 to the second end 36 of the shaft 26. The resilience of the spring 46 and the core 44 facilitate resilient return to a linear configuration of the shaft 26 when no external force is applied to the shaft 26 either directly or indirectly such as through force applied to the support 12. A combined resulting resistance to deformation, or bending of the shaft 26 from the core 44 and the spring 46 is designed to be low enough to allow the shaft 26 to remain in a bended condition while the infant bottle 14, or support 12, or the shaft 26 itself is grasped by an infant. Thus, the device 10 supports the infant bottle for the infant while allowing the infant to hold the infant bottle in position to allow for feeding from the nipple 42. Upon release of the force on the support 12, infant bottle 14, or shaft 26 itself, the resilience of the core 44 and spring 46 returns the shaft 26 to a linear and upright orientation as described above. The material of the core 44 and resilience of the spring 46 are such that the combined total resilience is enough to return the shaft 26 to the linear orientation in a measured time to optimize return to the vertical orientation to inhibit spillage through the nipple 42, meaning slow enough to prevent startling of the infant. A casing 50 is tubular and covers the spring 46 and the core 44. An outer shell 52 may cover the casing 50. The outer shell 52 may also be constructed of a resilient material similar to or the same as the material used for the core 44. Resilience of the outer shell 52 may be minimal such as to allow for deformation of the outer shell 52 with the movement of the shaft 26 but without substantially adding to or resisting the resilience of the shaft 26 as provided by the core 44 and spring 46.

The bracket connector 22 is angled for holding the bracket 16 at an angle relative to the shaft 26 such that the bracket 16 holds the infant bottle 14 with the nipple 42 extending upwardly and away from the first end 28 of the shaft 26 when the shaft 26 is in an unbent vertical orientation. The shaft 26 includes a support receiver 54 extending into the first end 28 of the shaft 26. A support connector 56 is coupled to the support 12. The support connector 56 is engageable to the support receiver 54 such that the support 12 is removably coupled to the first end 28 of the shaft 26. The support connector 56 may be a threaded post wherein the support connector 56 is threadedly couplable to the support receiver 54. Similarly, the shaft 26 includes a mount receiver 58 extending into the second end 36 of the shaft 26. A mount connector 60 is coupled to the mount 24 and is engageable to the mount receiver 58 such that the mount 24 is removably coupled to the second end 36 of the shaft 26. The mount connector 60 may also be a threaded post such that the mount connector 60 is threadedly couplable to the mount receiver 58.

The mount 24 is configured for securement to a supporting structure 64. The mount 24 may be a clamp 66 having a fixed jaw 68 and an opposing movable jaw 70 for securement of the supporting structure 64 between the fixed jaw 68 and the opposing movable jaw 70. The fixed jaw 68 may be an arm 72 of a yoke 74 and the opposing movable jaw 70 may be a turnscrew 76 extending through the yoke 74 opposite the arm 72 of the yoke 74. Alternatively and interchangeably, the mount 24 may be a suction cup 78 configured for being secured to a surface 80 of the supporting structure 64.

In use, the desired mount 24 is chosen and attached to the shaft 26. The mount 24 is secured to the supporting structure 64. The infant bottle 14 is secured to the support 12. The device 10 may be positioned close enough to the infant to allow the infant, if so capable, to reach the shaft 26, support 12, or infant bottle 14 to pull the infant bottle 14 and position the infant bottle 14 for drinking from the nipple 42. Upon release, either intentional or unintentional by the infant, resilience of the shaft 26 as provided in the core 44 and spring 46, the shaft 26 will return to a linear orientation supporting the infant bottle 14 with the nipple 42 being elevated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An infant bottle holding device comprising:
a support configured for holding an infant bottle;
a mount configured for securement to a supporting structure;
a shaft having a first end coupled to said support and a second end coupled to said mount, said shaft being resiliently deformable such that said shaft is configured for bending between a drinking position and a support position, said drinking position being configured for supporting the infant bottle in a tilted position having a nipple of the infant bottle facing downwardly allowing an infant to drink from the infant bottle, said support position having said shaft extending upwardly from said mount wherein said support is configured to hold the infant bottle with the nipple of the infant bottle facing upwardly inhibiting spillage from the infant bottle through the nipple.

2. The infant bottle holding device of claim 1, further comprising said mount being a clamp.

3. The infant bottle holding device of claim 2, further comprising said clamp including a fixed jaw and an opposing movable jaw wherein said clamp is configured for securement of the supporting structure between the fixed jaw and the opposing movable jaw.

4. The infant bottle holding device of claim 3, further comprising said fixed jaw being an arm of a yoke, said opposing movable jaw being a turnscrew extending through said yoke opposite said arm of said yoke.

5. The infant bottle holding device of claim 1, further comprising said mount being a suction cup configured for being secured to a surface of the supporting structure.

6. The infant bottle holding device of claim 1, further comprising said support including:
a bracket, said bracket being L-shaped wherein said bracket is configured for extending along a bottom and a side of the infant bottle;
a bracket connector coupled to said bracket and said first end of said shaft; and
a strap coupled to said bracket connector, said strap being configured for extending around said bracket and the infant bottle, said strap being securable into a closed loop wherein said strap is configured for securing the infant bottle to said support.

7. The infant bottle holding device of claim 6, further comprising complementary portions of hook and loop fastener coupled to said strap for securing said strap in said closed loop.

8. The infant bottle holding device of claim 6, further comprising said bracket connector holding said bracket at an angle relative to said shaft such that said bracket is configured for holding the infant bottle with the nipple of the bottle extending upwardly and away from said first end of said shaft when said shaft is in an unbent vertical orientation.

9. The infant bottle holding device of claim 1, further comprising said shaft including:
a core, said core being elongated between said first end of said shaft and said second end of said shaft, said core being constructed of a resiliently deformable material;
a spring, said spring being helical, said core extending through a center of said spring such that said spring wraps around said core from said first end of said shaft to said second end of said shaft; and
a casing, said casing being tubular, said casing covering said spring and said core.

10. The infant bottle holding device of claim 9, wherein said shaft further comprises an outer shell, said outer shell covering said casing, said outer shell being constructed of a resilient material.

11. The infant bottle holding device of claim 1, further comprising:
a support receiver in said shaft, said support receiver extending into said first end of said shaft; and
a support connector coupled to said mount, said support connector being engageable to said support receiver such that said support is removably coupled to said first end of said shaft.

12. The infant bottle holding device of claim 11 wherein said support connector is threadedly couplable to said support receiver.

13. The infant bottle holding device of claim 1, further comprising:
a mount receiver in said shaft, said mount receiver extending into said second end of said shaft; and
a mount connector coupled to said mount, said mount connector being engageable to said mount receiver such that said mount is removably coupled to said second end of said shaft.

14. The infant bottle holding device of claim 13 wherein said mount connector is threadedly couplabe to said mount receiver.

15. An infant bottle holding device comprising:
a support configured for holding an infant bottle, said support including
a bracket, said bracket being L-shaped wherein said bracket is configured for extending along a bottom and a side of the infant bottle,
a bracket connector coupled to said bracket, and
a strap coupled to said bracket connector, said strap being configured for extending around said bracket and the infant bottle, said strap being securable into a closed loop wherein said strap is configured for securing the infant bottle to said support, complementary portions of hook and loop fastener being coupled to said strap for securing said strap in said closed loop;
a mount configured for securement to a supporting structure;
a shaft having a first end coupled to said support and a second end coupled to said mount, said bracket connector being coupled to said first end of said shaft, said shaft being resiliently deformable such that said shaft is configured for bending between a drinking position and a support position, said drinking position being configured for supporting the infant bottle in a tilted position having a nipple of the infant bottle facing downwardly allowing an infant to drink from the infant bottle, said support position having said shaft extending upwardly from said mount wherein said support is configured to hold the infant bottle with the nipple of the infant bottle facing upwardly inhibiting spillage from the infant bottle through the nipple, said shaft including
a core, said core being elongated between said first end of said shaft and said second end of said shaft, said core being constructed of a resiliently deformable material,
a spring, said spring being helical, said core extending through a center of said spring such that said spring wraps around said core from said first end of said shaft to said second end of said shaft,
a casing, said casing being tubular, said casing covering said spring and said core, and
an outer shell, said outer shell covering said casing, said outer shell being constructed of a resilient material;
said bracket connector holding said bracket at an angle relative to said shaft such that said bracket is configured for holding the infant bottle with the nipple of the bottle extending upwardly and away from said first end of said shaft when said shaft is in an unbent vertical orientation;
a support receiver in said shaft, said support receiver extending into said first end of said shaft;
a support connector coupled to said mount, said support connector being engageable to said support receiver such that said support is removably coupled to said first end of said shaft, wherein said support connector is threadedly couplable to said support receiver;
a mount receiver in said shaft, said mount receiver extending into said second end of said shaft; and
a mount connector coupled to said mount, said mount connector being engageable to said mount receiver such that said mount is removably coupled to said second end of said shaft, wherein said mount connector is threadedly couplabe to said mount receiver.

16. The infant bottle holding device of claim 15, further comprising said mount being a clamp, said clamp including a fixed jaw and an opposing movable jaw wherein said clamp is configured for securement of the supporting structure between the fixed jaw and the opposing movable jaw, said fixed jaw being an arm of a yoke, said opposing movable jaw being a turnscrew extending through said yoke opposite said arm of said yoke.

17. The infant bottle holding device of claim 15, further comprising said mount being a suction cup configured for being secured to a surface of the supporting structure.
